(19) United States
(12) Patent Application Publication
(10) Pub. No.: US 2007/0114857 A1
(43) Pub. Date: May 24, 2007

(54) Rotor device

(76) Inventor: Wen-Hao Liu, Taipei (TW)

Correspondence Address: G. LINK CO. LTD., 3550 BELL ROAD, MINOOKA, IL, 60447, US

(21) Appl. No.: 11/281,808

(22) Filed: Nov. 18, 2005

(51) Int. Cl. H02K 9/00; H02K 7/00; H02K 1/22

(52) U.S. Cl. 310/58; 310/261; 310/67 R

(57) ABSTRACT

A rotor device includes a hub and a case member disposed in the hub. The hub has a closed end and an open end with the outer surface of the closed end providing a first opening and the inner surface of closed end providing a second opening. The characteristics are a slant flow passage is disposed between the first opening and the second opening and communicates with the first opening for increasing fluid flow and preventing from foreign objects entering the hub and the case member via the flow passage and the second opening.

### BACKGROUND OF THE INVENTION

1. Field of the Invention

The present invention is related to a rotor device and particularly to a rotor assembly, which can remove heat generated from running of the rotor.

2. Brief Description of the Related Art

Referring to FIGS. 1, a conventional fan rotor device with heat dissipation structure includes a hub 11 and a case member 12, which is disposed in the hub 12. The hub 11 has a closed end 111 and an open end 112 and a lateral wall 113 connects with the closed end 111 and the open end 112. The closed end 111 provides at least an opening 114 with an inner wall along the axial direction and the case member 12 is closely next to the inner side of the lateral wall 113 and provides a top wall 121 closely next to the closed end Ill of the hub 11. The top wall 121 provides a through hole 122 with an inner wall extending along an axial direction corresponding to the opening 114 of the hub 11 and a spindle 13 is disposed at the inner side of the top wall 121. Referring to FIG. 2, another conventional fan rotor device with heat dissipation structure almost the same as the fan rotor shown in FIG. 1 and the difference of the fan rotor shown in FIG. 2 is in that the hub 21 has a lateral wall 213 and the lateral wall 213 provides a shoulder part 211 extending toward the center of the hub 21 at an end thereof next to the top wall 121. The shoulder part 211 are arranged not to exceed the through hole 122 of the case member, that is, the hub 21 has a hollow space 212 next to the top wall 121 of the case member 12 to expose the top wall 121 and the through hole 122. Referring to FIG. 3, a further conventional fan rotor device with heat dissipation structure almost the same as the fan rotor shown in FIG. 1 and the difference of the fan rotor shown in FIG. 3 is in that the case member 22 provides a lip part 221 toward the center of the case member 22 next to the closed end 111 of the hub 11 and lip part is arranged not to exceed the opening 114 of the closed end 111 with the spindle 23 is disposed at the closed end 111 of the hub 11.

However, a common problem resided in the preceding three conventional rotor devices is explained hereinafter. When the hub (11, 21) and the case member (12, 22) rotate, fluid in the hub (11, 21) and the case member (12, 22) is induced to flow centrifugally such that radial pressure of the fluid increases and fluid in the case member (12, 22) near the lateral wall (113, 213) of the hub (11, 21) increases intensity thereof. Once the density of the fluid is greater than fluid outside the opening 114 and the through hole 121, the fluid with higher density is capable of moving outward via the opening 113 and the through hole 121, that is, the fluid changes flow path due to radial pressure thereof increasing. When the fluid passes through the opening 114 and the through hole 121, the radial pressure has to change to axial pressure during the fluid passing through the opening 114 and the through hole 121 due to the opening 114 and the through hole 121 providing the inner walls thereof being along the axial direction. As a result, impedance is formed to lower velocity of the fluid while the fluid and a lower heat convection efficiency is obtained to degrade heat dissipation effect.

Further, US Patent Publication No. 2004/0075356 entitled “FAN ROTOR”, Taiwanese Patent Gazette No. 566751 entitled “ROTOR ASSEMBLY” and Taiwanese Patent Gazette No. 568508 entitled “GOOD SELF HEAT DISSIPATION FAN” disclose a hub or a case member or a hub with a case member provides openings in order to remove heat generated by the rotor and the stator. The inner walls of the these openings are along the axial direction and it is the same as the preceding three conventional rotor device so that heat is unable to flow outward smoothly too.

### SUMMARY OF THE INVENTION

An object of the present invention is to provide a rotor device capable of dissipating heat and resisting foreign objects in which the hub holes offset the through holes in the shield case for preventing the foreign objects from entering the rotor device and for the fluid moving in and out for attaining purposed of heat dissipation.

Another object of the present invention is to provide a rotor device in which the hub provides a first opening at the outer surface thereof with a first lateral side corresponding to or exceeding a fourth lateral side of a second opening at the inner surface thereof along X-axis for preventing from foreign objects falling into the hub and allowing fluid passing through the first opening, the second opening and a flow passage communicating with the first and second openings.

A rotor device according to the present invention includes a hub and a case member disposed in the hub. The hub has a closed end and an open end with the outer surface of the closed end providing a first opening and the inner surface of closed end providing a second opening. The characteristics are a slant flow passage is disposed between the first opening and the second opening and communicates with the first opening for increasing fluid flow and preventing from foreign objects entering the hub and the case member via the flow passage and the second opening.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the a conventional rotor;

FIG. 2 is a sectional view of another conventional rotor;

FIG. 3 is a sectional of a further conventional rotor;

FIG. 4 is an exploded perspective view of the first embodiment of a rotor according to the present invention;

FIG. 5 is a perspective view of the first embodiment of a rotor according to the present invention;

FIG. 6 is a sectional view of the first embodiment of a rotor according to the present invention;

FIG. 7 is a fragmentary sectional view of illustrating the opening and the through hole shown in FIG. 6;

FIG. 8 is a sectional view illustrating the first embodiment of a rotor according to the present invention being applied to a fan motor;

FIG. 9 is a sectional view illustrating another type of the first embodiment of a rotor according to the present invention;

FIG. 10 is a fragmentary sectional view of illustrating the opening and the through hole shown in FIG. 9;

FIG. 11 is a sectional view of the second embodiment of a rotor according to the present invention; and

FIG. 12 is a top view of the third embodiment of a rotor according to the present invention.

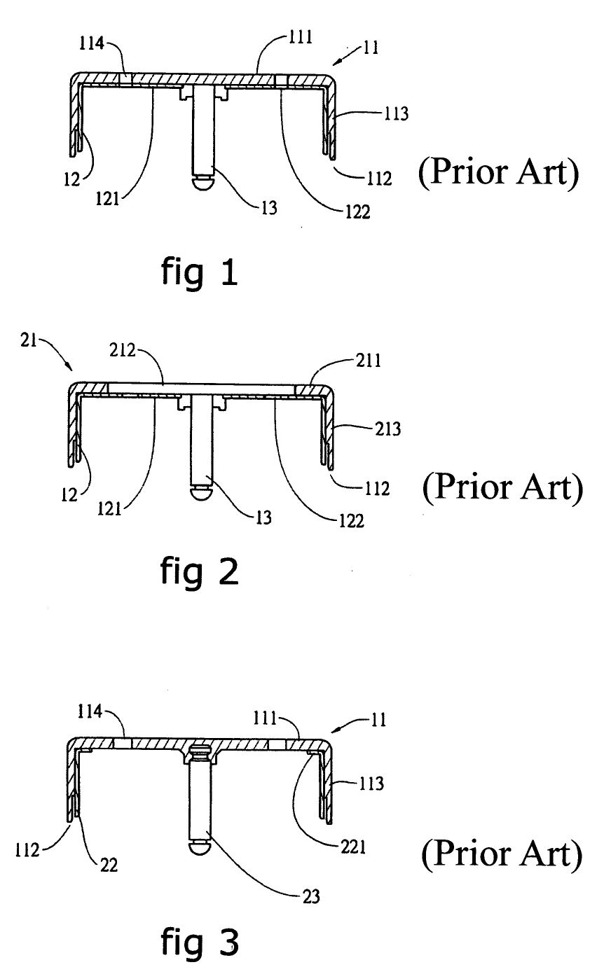

### DETAILED DESCRIPTION OF THE INVENTION

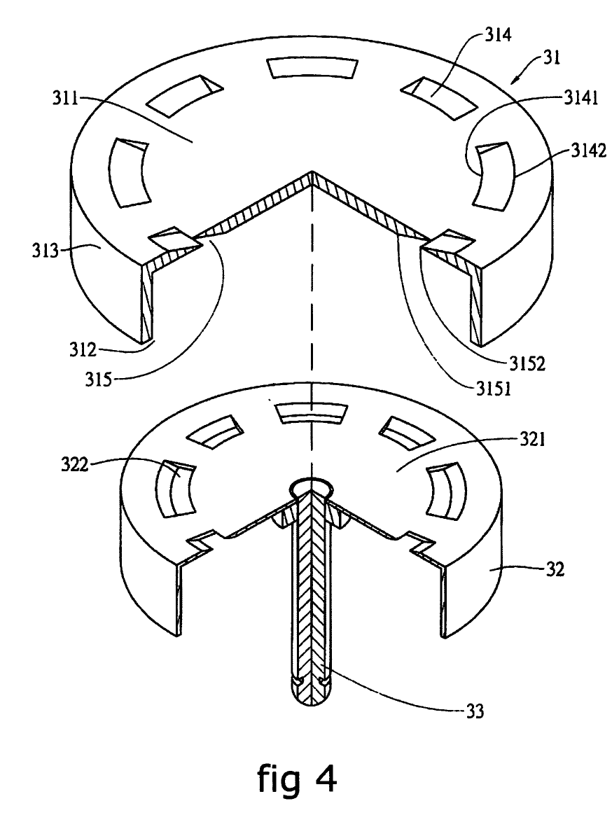

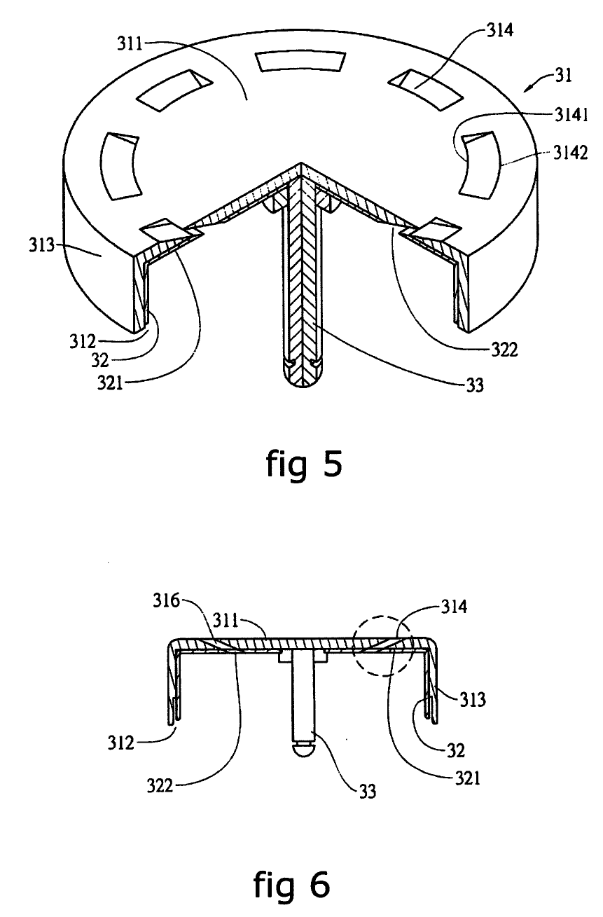

Referring to FIGS. 4 and 5, the first preferred embodiment of a rotor device is illustrated. The rotor device shown in FIGS. 4 and 5 includes a hub 31 and a case member 32. The hub 31 has a closed end 311, an open end 312 and a lateral wall 313 between the closed end 311 and the open end 312 is integrally joined the closed end 311. The closed end 311 provides at least a first opening 314 at the outer surface thereof and at least a second opening 315 at the inner surface of the closed end. A flow passage 316 is disposed between the first opening 314 and the second opening 315 to communicate both of the openings 314, 315. The flow passage 316 has an oblique shaped passage wall. The respective first opening 314, the respective second opening 315 and the flow passage 316 are disposed along the circumferential direction and the passage wall of the flow passage 316 is slant outward. It is noted that the flow passage 316 slanting outward is one of the examples and it can be slant in any directions. The case member 32 is next to the hub 31 with a top wall 321 adjoining the closed end 311 and provides at least a through hole 322 corresponding to the second opening 315. The inner wall of the through hole 322 is slant outward as the flow passage 316 does and a spindle 33 is disposed at the center of the top wall 321 of the case member 32.

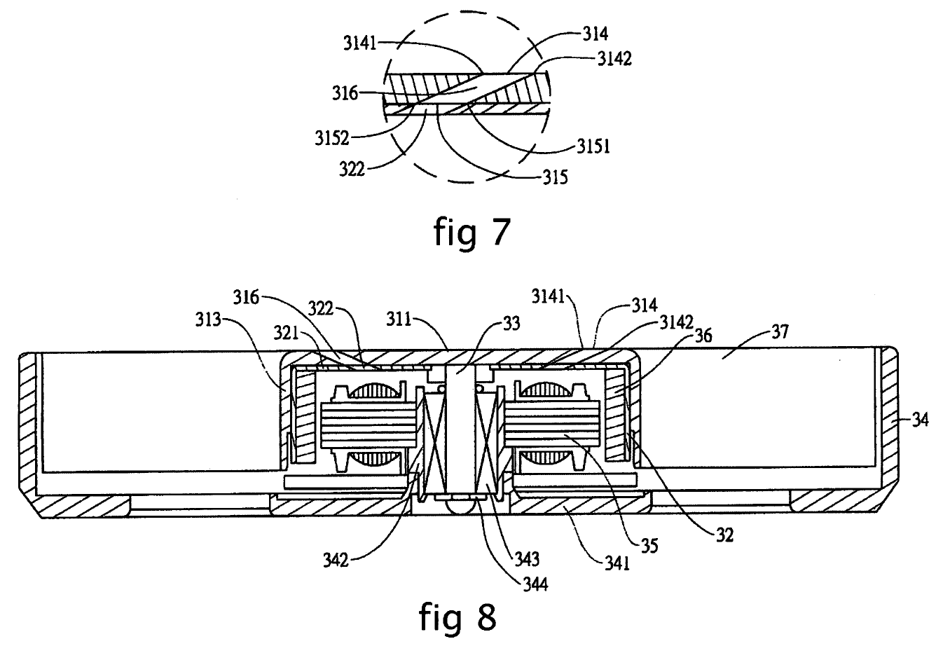

Referring to FIGS. 6 and 7 with reference FIGS. 4 and 5 again, the first opening 314 has a first lateral side 3141 facing the center of the hub 31 and has a second lateral side 3142 near the periphery of the hub 31. The second opening 315 has a fourth lateral side 3 152 facing the center of the hub 31 and has a third lateral side 3151 near the periphery of the hub 31. The first lateral side 3141 is disposed at least corresponding to the third lateral side 3151 or exceeding the third lateral side 3151 along X-axis of the cross section shown in FIG. 7. That is, it is impossible to see the inner surface of the second opening 315 from outer surface of the first opening 314 such that the foreign objects is incapable of falling into the hub 31 and the case member 32 directly via the first opening 314 and the second opening 315.

Referring to FIGS. 7 and 8 in company with FIG. 4, a fan frame 34 has a support base 341 therein and the support base 341 has a hollow barrel 342 with a bearing 343 and a retaining ring 344 inside and fitting with a stator 35 outside. A rotor 36 is disposed inside the case member 32 and a plurality of fan blades 37 extending outward from the hub 31. The spindle 33 passes through the bearing 343 and the retaining ring 344 catches the spindle 33 before the hub 31 and the case member 32 being movably joined to the support base 341 in the fan frame 34 such that the stator 35 is capable of magnetically connecting with the rotor 36. Once the stator 35 and the rotor 36 are magnetized to drive the hub 31 and the case member 32, the fan blades 37 rotates to induce fluid moving and relative rotation between the stator 35 and the rotor 36 physically changes from magnetic action to kinetic energy and then changes to heat energy. Under this circumference, it results in fluid in the hub 31 and the case member 32 increases temperature and radial pressure thereof and moves toward periphery of the case member 32 centrifugally. The fluid with greater radial pressure is capable of passes through the first opening 314, the second opening 315, the flow passage 316 and the through hole 322 to flow outward smoothly due to the flow passage 316 communicating with the first opening 314 and the second opening 315 and the inner wall of the through hole 314 being slant for promoting flow velocity and enhancing efficiency of convection. In addition, the temperature risen fluid is capable of lowering temperature thereof largely to promote heat dissipation effect thereof such that deficiency resulting from the openings and the through hole being along the axial direction and the fluid being unable to pass through the openings and the through hole smoothly and rapidly can be overcome completely. Further, the first lateral side 3141 of the first opening 314 being disposed at least corresponding to the third lateral side 3151 or exceeding the third lateral side 3151 along X-axis of the cross section prevents the foreign objects falling into the hub 31 and the case member 32 directly via the first opening 314 and the second opening 315 for avoiding running between the stator 35 and the rotor 36.

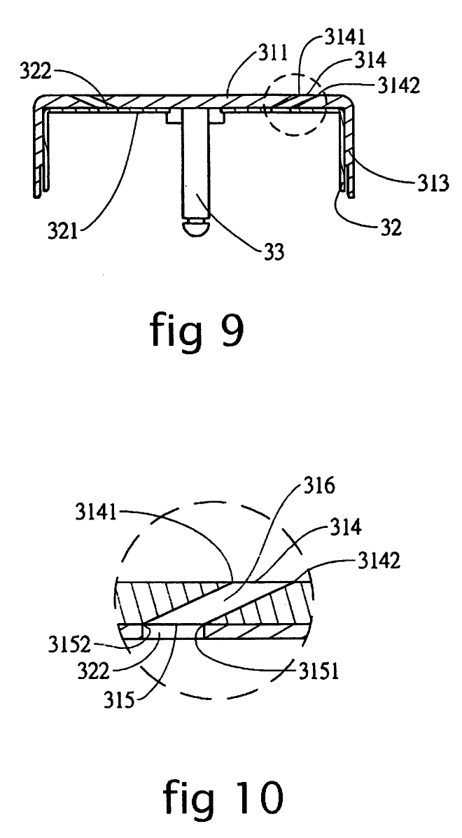

Referring to FIGS. 9 and 10, the inner wall of the through hole 322 in the case member 32 can be arranged to be non-slant and the same effect can be achieved as well.

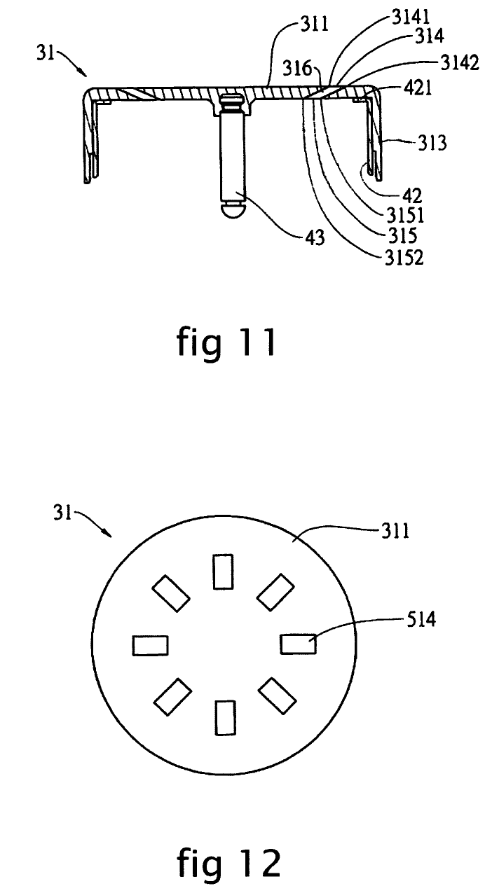

Referring to FIG. 11, the second embodiment of a rotor device according to the present invention is illustrated. The second embodiment is almost the same as the first embodiment in structure, function and implement and the identical parts are designated with the same reference number and no details will be described further. The difference of the present embodiment is in that the case member 42 provides a projection 4211 extends toward the center thereof but not exceeds the opening 314 and the spindle 43 is attached to the closed end of the hub 31.

Referring to FIG. 12, the third embodiment of a rotor device according to the present invention is illustrated. The second embodiment is almost the same as the first embodiment in structure, function and implement and the identical parts are designated with the same reference number and no details will be described further. The difference of the present embodiment is in that the openings 514 at the closed end 311 of the hub 31 are disposed along radial direction.

In addition, the openings at the closed end 311 of the hub 31 can be arranged in a direction other than the opening 314, which is along circumferential direction, and the opening 514, which is along radial direction, to achieve the preceding functions and effects as well.

While the invention has been described with referencing to preferred embodiments thereof, it is to be understood that modifications or variations may be easily made without departing from the spirit of this invention, which is defined by the appended claims.

What is claimed is:

1. A rotor device, comprising:
a hub, having a closed end and an open end with the outer surface of the closed end providing a first opening and the inner surface of closed end providing a second opening and a slant flow passage being disposed between and connecting with the first opening and the second opening; and
a case member, being disposed in the hub.

2. The rotor device as defined in claim 1, wherein the case member has a top wall adjacent to the closed end of the hub and the top wall provides at least a through hole corresponding to the second opening.

3. The rotor device as defined in claim 2, wherein the through hole has a non-slant inner wall.

4. The rotor device as defined in claim 2, wherein the through hole has a slant hole.

5. The rotor device as defined in claim 1, wherein case member has a projection toward the center of the case member.

6. The rotor device as defined in claim 1, wherein the first opening, the second opening and the flow passage are disposed along a circumferential direction or a radial direction.
